(19) United States
(12) Patent Application Publication
(10) Pub. No.: US 2008/0117062 A1
(43) Pub. Date: May 22, 2008

(54) Animal contact verification or analysis system

(76) Inventor: Richard Joseph Wessels, Scandia, MN (US)

Correspondence Address: RICHARD J. WESSELS, 22195 KIRK AVE N., SCANDIA, MN, 55073, US

(21) Appl. No.: 11/602,789

(22) Filed: Nov. 21, 2006

(51) Int. Cl. A63K 3/00; G08B 23/00

(52) U.S. Cl. 340/573.1; 119/422

(57) ABSTRACT

This document discusses, among other things, a system and method for detecting a physical contact within a specified area of at least one piece of dog agility equipment for the purpose of improving the training and judging involved in the sport of dog agility. A notification of a proper detected physical contact can be provided using a physical indicator, such as a light or a sound, or an electromagnetic signal, configured to be received by an electronic device.

### TECHNICAL FIELD

This patent document pertains generally to contact sensors, and more particularly, but not by way of limitation, to detecting a physical contact within a specified area of at least one piece of dog or other animal agility equipment.

### BACKGROUND

The competitive sport of dog agility includes the task of having a dog traverse various obstacles including ramps, teeter-totters, A-frames, and tables. Typically, there is a performance requirement that the dog touch certain areas, or “contact zones,” on the obstacle while traversing it. For example, the American Kennel Club (AKC) requires that a minimum of a dog's toenail must be within the contact zone to establish a valid contact. Other canine registries typically impose similar requirements. The present practice generally includes observing the behavior with the human eye and making a judgment as to whether a proper contact was made or not. This can often be difficult and inaccurate due to the speed and physical characteristics of modem canine athletes. World class canine athletes can typically traverse the contact zone in less than 0.2 seconds, and further, many dogs have long hair on their feet that can prevent the judge from making an accurate assessment of a valid contact. Thus, there exists a need to increase the accuracy and consistency of judging a proper contact.

### OVERVIEW

This overview is intended to provide an overview of the subject matter of the present patent application. It is not intended to provide an exclusive or exhaustive explanation of the invention. The detailed description is included to provide further information about the subject matter of the present patent application.

In Example 1, a system is configured to detect a physical contact by an animal, such as a dog or other animal, within a specified area of at least one piece of dog agility equipment. The system includes at least one contact sensor, configured to sense an electrical characteristic indicative of the physical contact. The system also includes a detection circuit, coupled to the contact sensor, configured to detect the physical contact using information from the contact sensor. The system also includes a notification circuit, coupled to the detection circuit, configured to provide a notification of the detected physical contact.

In Example 2, the system of Example 1 optionally includes at least one piece of dog agility equipment, wherein the at least one piece of dog agility equipment includes at least one of a ramp, a tunnel, a chute, a teeter-totter, a dog-walk, an A-frame, and a table.

In Example 3, the at least one piece of dog agility equipment of Examples 1-2 optionally includes a grounding circuit, wherein the grounding circuit includes a conductor, and wherein the conductor is configured to be connected to an electrical ground.

In Example 4, the at least one contact sensor of Examples 1-3 optionally includes a plurality of contact sensors, wherein the plurality of contact sensors are configured to operate as one or more than one contact zone.

In Example 5, the plurality of contact sensors of Examples 1-4 are optionally configured, individually or in combination, to operate as one or more than one contact zone.

In Example 6, the contact sensor of Examples 1-5 optionally includes a conductor.

In Example 7, the contact sensor of Examples 1-6 optionally includes at least one signal conductor and at least one ground conductor.

In Example 8, the detection circuit of Examples 1-7 optionally includes a signal generation circuit, configured to generate a electrical signal using information from the contact sensor. The detection circuit of Examples 1-7 is also optionally configured to detect the physical contact using information from the generated electrical signal.

In Example 9, the detection circuit of Examples 1-8 is optionally configured to detect a change in the electrical characteristic indicative of the physical contact. The system of Examples 1-8 also optionally includes a timing circuit, coupled to the detection circuit, configured to determine whether the change in the electrical characteristic meets or exceeds a specified duration. The notification circuit of Examples 1-8 is also optionally coupled to the timing circuit. The notification circuit of Examples 1-8 is also optionally configured to provide a notification using information from the timing circuit.

In Example 10, the notification circuit of Examples 1-9 optionally includes a physical indicator, wherein the physical indicator includes at least one of a light and a sound.

In Example 11, the notification circuit of Examples 1-10 optionally includes an electromagnetic signal configured to be received by an electronic device.

In Example 12, a system includes means for sensing an electrical characteristic indicative of a physical contact by an animal within a specified area of at least one piece of dog agility equipment, such as by using at least one contact sensor, configured to sense an electrical characteristic indicative of the physical contact. The system also includes means for detecting the physical contact using the sensed electrical characteristic, such as by using a detection circuit, coupled to the contact sensor, configured to detect the physical contact using information from the contact sensor. The system also includes means for providing a notification of the detected physical contact, such as by using a notification circuit, coupled to the detection circuit, configured to provide a notification of the detected physical contact.

In Example 13, a method includes sensing an electrical characteristic indicative of a physical contact by an animal, such as a dog or other animal, within a specified area of at least one piece of dog agility equipment using a contact sensor. The method also includes detecting the physical contact using the sensed electrical characteristic. The method also includes providing a notification of the detected physical contact.

In Example 14, the sensing of Example 13 optionally includes sensing an electrical characteristic within one or more than one specified area using a plurality of contact sensors.

In Example 15, the sensing of Examples 13-14 optionally includes using a contact sensor that includes a conductor.

In Example 16, the sensing of Examples 13-15 optionally includes using a contact sensor that includes at least one signal conductor and at least one ground conductor.

In Example 17, the method of Examples 13-16 optionally includes generating an electrical signal using information from the sensed electrical characteristic. The detecting the physical contact of Examples 13-16 also optionally includes using information from the generated electrical signal.

In Example 18, the method of Examples 13-17 optionally includes detecting a change in the electrical characteristic indicative of the physical contact. The method of Examples 13-17 also optionally includes determining whether the change in the electrical characteristic meets or exceeds a specified duration using a timing circuit. The providing a notification of Examples 13-17 optionally includes using information from the timing circuit.

In Example 19, the providing a notification of Examples 13-18 optionally includes providing a physical indication, wherein providing the physical indication includes providing at least one of a light and a sound.

In Example 20, the providing a notification of Examples 13-19 optionally includes providing an electromagnetic signal, configured to be received by an electronic device.

This overview is intended to provide an overview of the subject matter of the present patent application. It is not intended to provide an exclusive or exhaustive explanation of the invention. The detailed description is included to provide further information about the subject matter of the present patent application.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates generally an example of a system including a piece of dog agility equipment, contact zones, electrical cabling, a piece of electronic equipment, a light indication, a sound indication, an electromagnetic signal indication, a computer, a dog, a human operator, and wherein the contact zone includes cross section AA, cross section BB, and electrical connectors.

FIG. 2 illustrates generally an example of portions of a system including a portion of a piece of dog agility equipment, a conductive layer, a non-conductive layer, electrical connectors, an electrical insulating collar, threaded fasteners, electric cabling, and wherein the portion of the piece of dog agility equipment includes a frame, wood, and a non-conductive coating.

FIG. 3 illustrates generally an example of portions of a system including a portion of a piece of dog agility equipment, a contact zone, gaps, and interdigitated zones.

FIG. 4a illustrates generally an example of portions of a system including a portion of a piece of dog agility equipment, a conductive layer, a non-conductive layer, an electrical connection, a detection circuit, an electrical ground, and wherein the portion of the piece of dog agility equipment includes a frame, wood, and a non-conductive coating.

FIG. 4b illustrates generally an example of portions of a system including a portion of a piece of dog agility equipment, a conductive layer, a non-conductive layer, an electrical connection, a detection circuit, an electrical ground connection, an electrical ground, and wherein the portion of the piece of dog agility equipment includes a frame, wood, and a non-conductive coating.

FIG. 5 illustrates generally an example of portions of a system including an electrical characteristic and a detection circuit, wherein the detection circuit includes a sensor interface circuit, an analysis circuit, and an indicator circuit.

FIG. 6 illustrates generally an example of a system timing cycle including a main timing cycle, a clock signal, control signals, wherein the main timing signal includes a count interval and a control interval, and wherein the clock signal includes clock pulses during the count interval and clock pulses during the control interval.

FIG. 7 illustrates generally an example of portions of a system including an electrical characteristic and portions of a detection circuit, wherein the portions of the detection circuit include a sensor interface circuit and an analysis circuit, wherein the sensor interface circuit includes a variable monostable oscillator, a variable resistor, a thermister, signal lines, a fixed monostable oscillator, a fixed resistor, a fixed capacitor, and a control signal, and wherein the analysis circuit includes a fixed oscillator, combinational logic, a counter, a present value (n), a previous value (n-1), a comparator, and a notification signal.

FIG. 8 illustrates generally an example of portions of a system including an electrical characteristic and portions of a detection circuit, wherein the portions of the detection circuit include a sensor interface circuit and an analysis circuit, wherein the sensor interface circuit includes a variable astable oscillator, a variable resistor, a thermister, and a clock signal, and wherein the analysis circuit includes a fixed oscillator, a control signal, combinational logic, a counter, present value (n), previous value (n-1), a comparator, and a notification signal.

FIG. 9 illustrates generally an example of portions of a system including portions of a detection circuit, wherein portions of the detection circuit include a sensor interface circuit and an analysis circuit, wherein the sensor interface circuit includes an electrical characteristic, a variable oscillator, a variable resistor, a thermister, and a variable clock signal, and wherein the analysis circuit includes a fixed oscillator, microprocessor circuitry, general logic, memory, and a notification signal.

FIG. 10 illustrates generally an example of portions of a system including portions of a detection circuit, wherein portions of the detection circuit include an electrical characteristic, a variable oscillator, a digitally controlled resistor, a clock signal, a fixed oscillator, combinational logic, a counter, a counter signal, a reference value, a comparator, comparator signals, an up/down counter, a notification signal, a delay, a delay signal, a latch, and a latch signal.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Typically, electrical characteristics of a conductive surface within a contact zone can be used as a sensor to determine if an animal is present. The capacitance of the contact zone generally changes when an animal is present. This change can be detected and used to set an indicator, to start a timer, or to otherwise influence a different type of circuit or mechanism in order to detect contact. This technique can typically provide the speed and accuracy necessary to determine whether or not an animal has established a proper contact within the contact zone.

Generally, a clock signal can be established with a frequency that is dependent, at least in part, on a capacitance of a contact zone, such as to determine if an animal is present. A control signal can be used to determine a time interval during which clock pulses can be counted. Each count can be saved and compared to a previous count. When a sufficient difference exists between the count and a previous count, an output signal can be set, such as to indicate that an animal is present at the contact zone. The output signal can be used to start a timer. The timer can be used to activate a notification signal. This notification signal can include a light, a sound, or an electromagnetic signal.

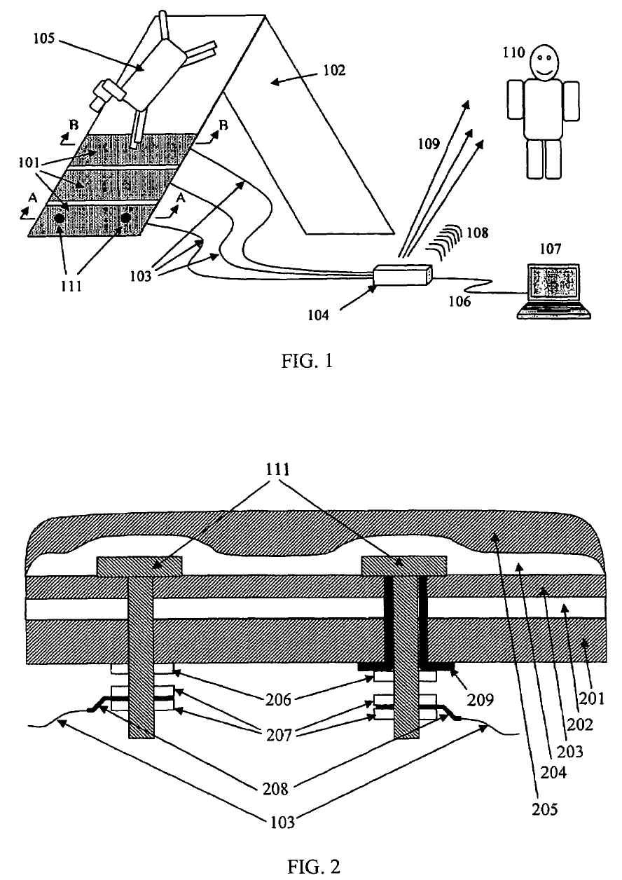

FIG. 1 illustrates generally an example of a system including a piece of dog agility equipment 102, electrical cabling 103, a piece of electronic equipment 104, a light indication 109, a sound indication 108, an electromagnetic signal indication 106, a computer 107, a dog 105, and a human operator 110, wherein the piece of dog agility equipment 102 includes contact zones 101, cross section AA, and cross section BB, and wherein the contact zones 101 include electrical connectors 111.

In this example, the dog 105 makes contact on a piece of dog agility equipment 102, e.g., an A-frame, with the contact zone 101. In certain examples, the contact zone 101 can include one or more than one section. In certain examples, the one or more than one section can be used to determine a more precise contact area within the contact zone 101, or the one or more than one section can be used to train the dog 105, or other animal, to make contact with a specific section of the contact zone 101.

In the example of FIG. 1, the electronic equipment 104 can include a detection circuit or a notification circuit, and generally can determine the presence or absence of an animal, such as a dog 105, in a contact zone 101, or detect a physical contact by an animal, such as a dog 105, in a contact zone 101. In certain examples, the electronic equipment 104 can be connected to the contact zone 101 with electric cabling 103 and can provide a switching mechanism to select one or more than one section of the contact zone 101, or one or more than one contact zone 101. In other examples, the electronic equipment 104 can provide a timing function to activate one or more than one indication, such as a light indication 109, a sound indication 108, an electromagnetic signal indication 106, etc., for a specified time, or the electronic equipment can provide a timing function to determine how long an animal, such as a dog 105, remains in the contact zone 101.

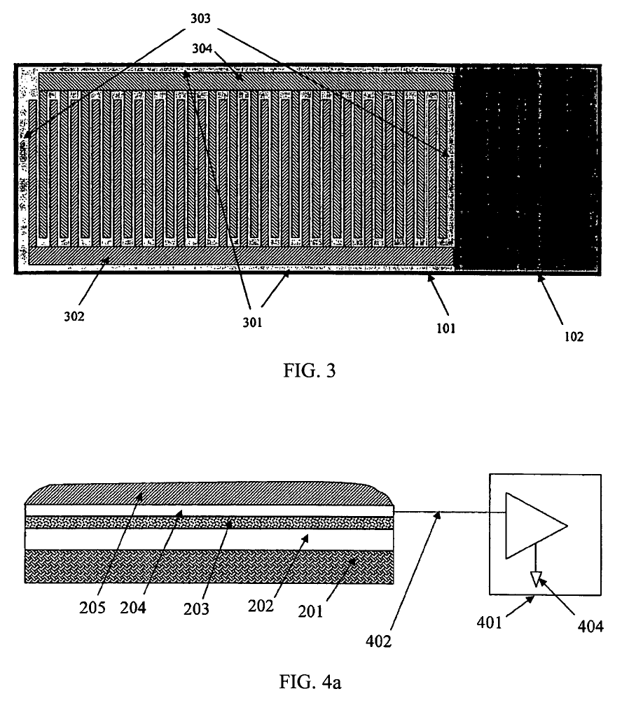

FIG. 2 illustrates generally an example of portions of a system including a portion of a piece of dog agility equipment 102, a conductive layer 204, a non-conductive layer 205, electrical connectors 111, threaded fasteners 206, 207, electric cabling 103, and wherein the portion of the piece of dog agility equipment 102 includes a frame 201, wood 202, and a non-conductive coating 203.

In this example, FIG. 2 displays the cross section AA of a contact zone 101 of the piece of dog agility equipment 102. In an example, the frame 201 of the piece of dog agility equipment 102 can be constructed of metal, wood, or other material. A covering, such as the wood 202, fiberglass, or other material, can be attached to the frame 201 to provide support. The non-conductive coating 203, typically includes a latex or oil base paint, though other materials can be used.

In the example of FIG. 2, the conductive layer 204 can be applied to the piece of dog agility equipment 102 to create a contact sensor. The area of the contact sensor includes the contact zone 101. In an example, the conductive layer can include a conductive paint, an epoxy, a metallic film, or other electrically conductive materials. In another example, the non-conductive coating 205 can be applied to protect the conductive layer 204. The electric connectors 111 can provide an electrical contact between the conductive layer 204 and the electric cabling 103. In an example, the electrical connectors 111 can include mechanical fasteners, bolts, or other electrical connectors to through the piece of dog agility equipment 102. In this example, the threaded fasteners 206 can provide mechanical stability to the electrical connectors 111. In another example, the threaded fasteners 207 and the electrical connectors 208 can provide an electrical connection between the electrical connectors 111 and the electric cabling 103 by compressing the electrical connectors 208 between the threaded fasteners 207. An electrically insulating collar 209 may be required to electrically isolate the electrical connector 111 from the piece of dog agility equipment 102 if for example, the frame 201 of the piece of dog agility equipment is made of a conductive material, such as aluminum, steel, or other conductive materials. In an example, the electrically insulating collar 209 can include plastic, paper, or other insulating material of sufficient length to isolate the electrical connector 111 from the piece of dog agility equipment 102.

FIG. 3 illustrates generally an example of portions of a system including a portion of a piece of dog agility equipment 102, a contact zone 101, gaps 301, 303, and interdigitated zones 302, 304.

In this example, the contact zone 101 of the piece of dog agility equipment 102 includes gaps 301, 303 and interdigitated zones 302, 304. The contact zone 101 generally includes at least one conductor. In this example, the contact zone 101 includes a first interdigitated zone 302 that can be used for an electrical signal and a second interdigitated zone 304 that can be used for an electrical ground. Generally, an electrical ground in close proximity to an electric signal results in a composite electric field closer in proximity to the contact zone 101, which typically allows for detection in the contact zone with an increased specificity. Further, in this example, the contact zone 101 includes gaps 301, 303. Generally, gaps 301, 303 decrease the possibility of falsely detecting a human operator 110. In an example, the gap 303 at the end of the contact zone 101 can be minimized to increase the differentiation of the contact zone 101 and the remaining piece of dog agility equipment 102. In other examples, other structures or geometries, such as a serpentine geometry, etc., can be used including a first conductor and at least a second conductor, wherein at least one of the conductors includes an electrical ground.

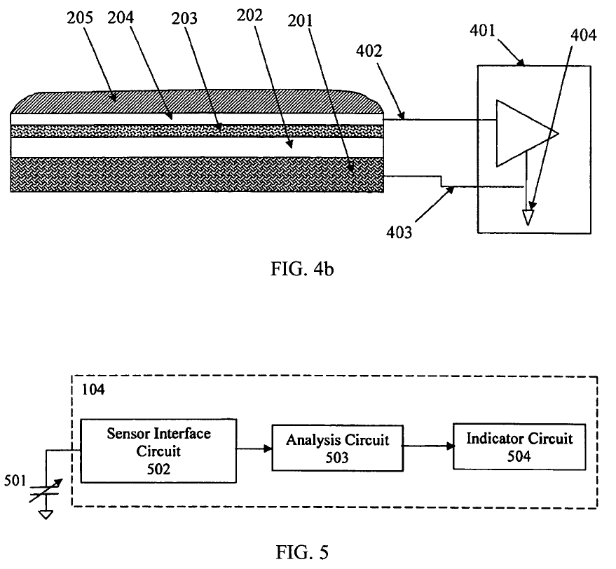

FIG. 4a illustrates generally an example of portions of a system including a portion of a piece of dog agility equipment, a conductive layer 204, a non-conductive layer 205, an electrical connection 402, a detection circuit 401, an electrical ground 404, and wherein the portion of the piece of dog agility equipment includes a frame 201, wood 202, and a non-conductive coating 203.

In this example, FIG. 4a displays the cross section BB of a contact zone 101 of the piece of dog agility equipment 102. In an example, the detection circuit 401 can be configured to receive an electrical characteristic from the conductive layer 204 using the electrical connection 402. In this example, the contact sensor includes the conductive layer 204.

FIG. 4b illustrates generally an example of portions of a system including a portion of a piece of dog agility equipment, a conductive layer 204, a non-conductive layer 205, an electrical connection 402, a detection circuit 401, an electrical ground connection 403, an electrical ground 404, and wherein the portion of the piece of dog agility equipment includes a frame 201, wood 202, and a non-conductive coating 203.

In this example, FIG. 4b displays the cross section BB of a contact zone 101 of the piece of dog agility equipment 102. In an example, the electrical ground 404 of the detection circuit 401 can be configured to be connected to the frame 201 of the piece of dog agility equipment 102. In another example, if the frame 201 does not include a conductor, a conductive layer can be applied on the back of the piece of dog agility equipment 102, which can then be connected to the electrical ground 404 of the detection circuit 401 using the electrical ground connection 403. In other examples, other electrical ground connections of the system can be configured to be connected to the frame 201 or an applied conductive layer on the back of the piece of dog agility equipment 102. Generally, the electrical ground connection 403 can provide a more controlled electrical capacitance. Typically, connecting the frame 201 to electrical ground ensures that the potential effects of the frame 201 will not adversely affect the detection circuit or other components.

FIG. 5 illustrates generally an example of portions of a system including an electrical characteristic 501 and a detection circuit 104, wherein the detection circuit 104 includes a sensor interface circuit 502, an analysis circuit 503, and an indicator circuit 504.

In this example, the contact zone is represented by an electrical characteristic 501. Generally, the contact zone 101 includes an electrical capacitance related to its physical size and proximity to other conductive objects. When an electrically active object, such as a dog 105, or other animal, is present in the contact zone 101, the electrical characteristic 501 of the contact zone 101 typically changes. The electrical characteristic 501 can be determined by the detection circuit 104. In an example, the sensor interface circuit 502 can be configured to receive the electrical characteristic 501. The analysis circuit 503 can be configured to determine if the electrical characteristic 501 has changed. The indicator circuit 504 can be configured to provide an indication if the analysis circuit 503 determines that a sufficient change in the electrical characteristic 501 has occurred. In certain examples, the indication can include a light indication 109, a sound indication 108, an electromagnetic signal indication 106, etc.

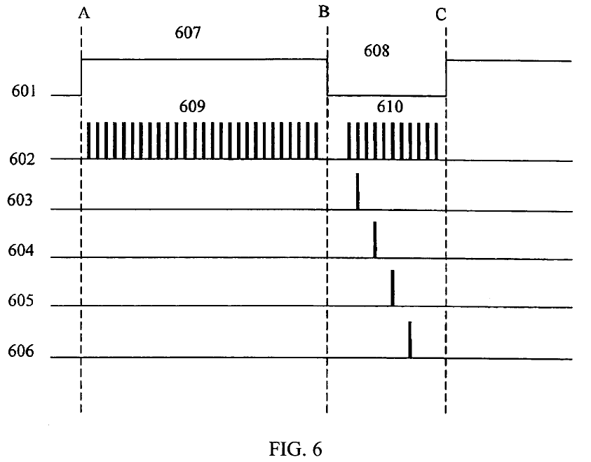

FIG. 6 illustrates generally an example of a system timing cycle including a main timing cycle 601, a clock signal 602, control signals 603-606, wherein the main timing signal 601 includes a count interval 607 and a control interval 608, and wherein the clock signal includes clock pulses 609 during the count interval 607 and clock pulses 610 during the control interval 608.

In this example, the main timing signal 601 includes the count interval 607 when the detection circuit 104 is detecting the electrical characteristic 501 and a control interval 608 when the detection circuit 104 is processing the electrical characteristic 501. In an example, the count interval 607 can extend from time marker A to time marker B and the control interval 608 can extend from time marker B to time marker C. In certain examples, the clock signal 602 can be used to generate clock pulses 609 that can be counted during the count interval 607, or the clock signal 602 can be used to generate control signals 603-606 using the clock pulses 610 during the control interval 608. The control signals 603-606 can be used to control various circuit functions, such as transferring a previous count, latching the present count, latching the result of a comparison, activating an indication if a valid contact is determined, etc.

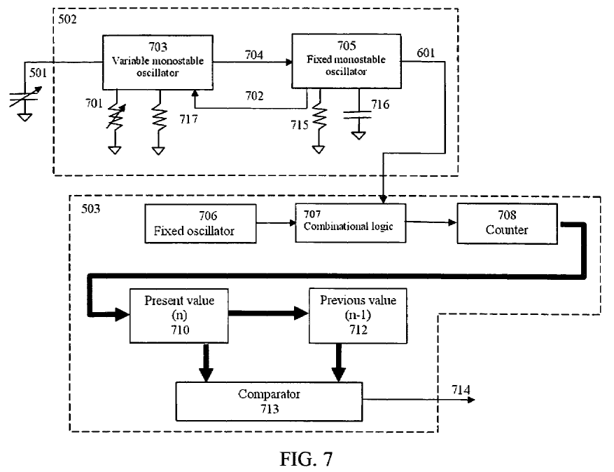

FIG. 7 illustrates generally an example of portions of a system including an electrical characteristic 501 and portions of a detection circuit, wherein the portions of the detection circuit include a sensor interface circuit 502 and an analysis circuit 503, wherein the sensor interface circuit 502 includes a variable monostable oscillator 703, a variable resistor 701, a thermister 717, signal lines 702, 704, a fixed monostable oscillator 705, a fixed resistor 715, a fixed capacitor 716, and a control signal 601, and wherein the analysis circuit 503 includes a fixed oscillator 706, combinational logic 707, a counter 708, a present value (n) 710, a previous value (n-1) 712, a comparator 713, and a notification signal 714.

In this example, the control signal 601 can be created using the electrical characteristic 501, the variable monostable oscillator 703, the fixed monostable oscillator 705, and various other circuit components. In an example, the count interval 607 can be created using the output of the variable monostable oscillator 703. The count interval 607 can be connected to the fixed monostable oscillator 705 using a signal line 704. The control signal 601 can be created using the output of the fixed monostable oscillator 705. Output of the fixed monostable oscillator 705 can be fed back to the variable monostable oscillator 703 using the signal line 702 this feedback connection can create an astable oscillator that can be used to create the control signal 601. In an example, the count interval 607 duration can be established using the electrical characteristic 501, the variable resistor 701, and the thermister 717. Generally, the variable resistor 701 can be used to compensate for differences in the electrical characteristic 501 of the piece of dog agility equipment 102, differences in temperature, differences in humidity, etc, and the thermister 717 can be used to accommodated temperature dependency of various electrical components or other components of the system. The control interval 608 duration can be established using the fixed resistor 715 and fixed capacitor 716.

In the example of FIG. 7, the analysis circuit 503 can be configured to receive the control signal 601. In an example, the counter 708 can be used to count the number of cycles of the fixed oscillator 706 during the count interval 607. In certain examples, the analysis circuit 503 can be configured to store the present value (n) 710 of this count, and the analysis circuit 503 can be configured to store the previous value (n-1) 712 of this count. The comparator 713 can be configured to compare the present value (n) 710 and the previous value (n-1) 712 to determine if any change has occurred. In an example, the notification signal 714 can be created using the output of the comparator 713.

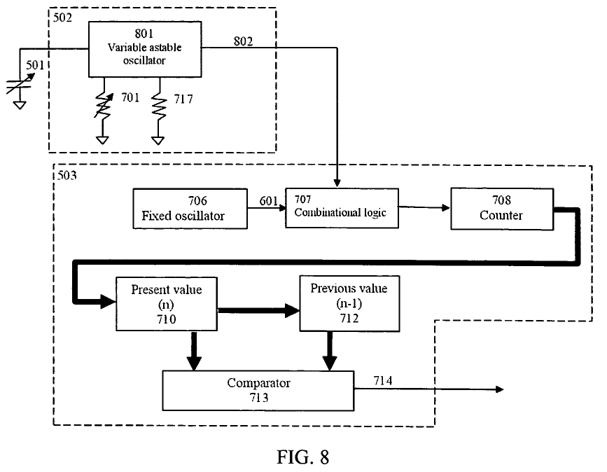

FIG. 8 illustrates generally an example of portions of a system including an electrical characteristic 501 and portions of a detection circuit, wherein the portions of the detection circuit include a sensor interface circuit 502 and an analysis circuit 503, wherein the sensor interface circuit includes a variable astable oscillator 801, a variable resistor 701, a thermister 717, and a clock signal 802, and wherein the analysis circuit 503 includes a fixed oscillator 706, a control signal 601, combinational logic 707, a counter 708, present value (n) 710, previous value (n-1) 712, a comparator 713, and a notification signal 714.

In this example, the clock signal 802 can be created using a sensor interface circuit 502 and an electrical characteristic 501, wherein the sensor interface circuit 502 includes a variable astable oscillator 801, a variable resistor 701, and a thermister 717. Generally, the clock signal 802 varies depending on the electrical characteristic 501 and the variable resistor 701. In an example, the electrical characteristic 501 includes the capacitance of the contact zone 101. The variable resistor 701 can be used to compensate for variance in the capacitance of the contact zone 101 between different pieces of dog agility equipment 102, temperature, humidity, or other system variables. In an example, the thermister 717 can be used to compensate for the temperature dependency of various system components.

In the example of FIG. 8, a control signal 601 can be provided using the fixed astable oscillator 706. In certain examples, the count interval 607 and the control interval 608 can be determined using the control signal 601. The counter 708 can be used to count the number of cycles of the variable astable oscillator 801 during the count interval 607. In certain examples, the analysis circuit 503 can be configured to store the present value (n) 710 of this count, and the analysis circuit 503 can be configured to store the previous value (n-1) 712 of this count. The comparator 713 can be configured to compare the present value (n) 710 and the previous value (n-1) 712 to determine if any change has occurred. In an example, the notification signal 714 can be created using the output of the comparator 713.

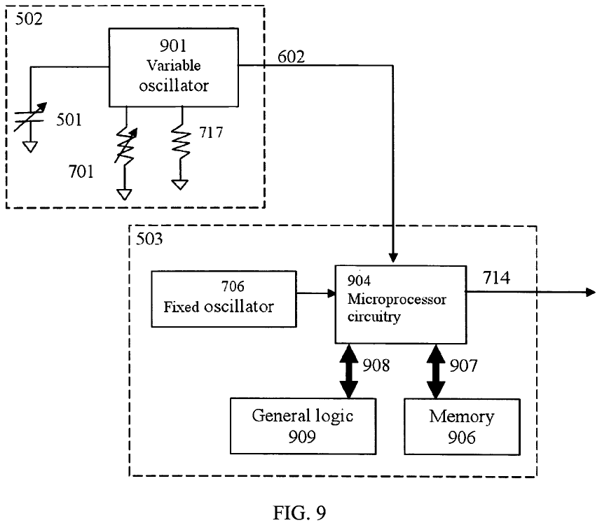

FIG. 9 illustrates generally an example of portions of a system including portions of a detection circuit, wherein portions of the detection circuit include a sensor interface circuit 502 and an analysis circuit 503, wherein the sensor interface circuit 502 includes an electrical characteristic 501, a variable oscillator 901, a variable resistor 701, a thermister 717, and a variable clock signal 602, and wherein the analysis circuit 503 includes a fixed oscillator 706, microprocessor circuitry 904, general logic 909, memory 906, and a notification signal 714.

In this example, a variable clock signal 602 can be created using a sensor interface circuit 502, wherein the sensor interface circuit 502 includes an electrical characteristic 501, a variable oscillator 901, a variable resistor 701, and a thermister 717. Generally, the variable clock signal 602 varies depending on the electrical characteristic 501 and the variable resistor 701. In an example, the electrical characteristic 501 includes the capacitance of the contact zone 101. The variable resistor 701 can be used to compensate for variance in the capacitance of the contact zone 101 between different pieces of dog agility equipment 102, temperature, humidity, or other system variables. In an example, the thermister 717 can be used to compensate for the temperature dependency of various system components.

In the example of FIG. 9, microprocessor circuitry 904 can be used to determine the count interval 607 and the control interval 608. Generally, the microprocessor circuitry 904 can be configured to execute a software code in conjunction with a memory 906 and general logic 909. In certain examples, the microprocessor circuitry 904 and memory 906 can be configured to count the number of cycles of the variable oscillator 901. In other examples, the microprocessor circuitry 904 and memory 906 can be configured to store the present value of this count and at least one previous value of this count. The microprocessor circuitry 904 can be configured to compare the present value and at least one previous value to determine if any change has occurred. In an example, the notification signal 714 can be created using the output of the microprocessor circuitry 904.

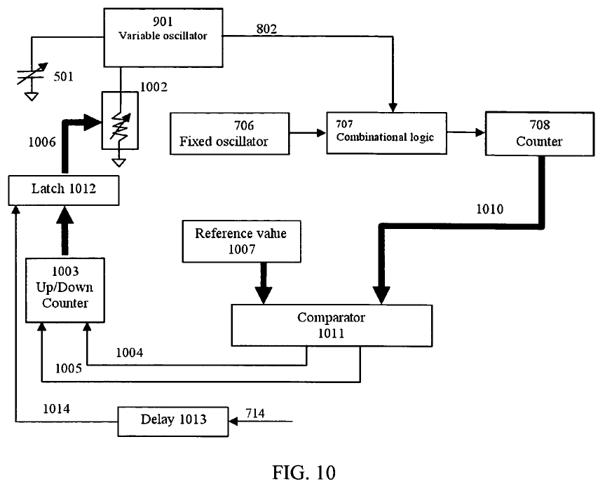

FIG. 10 illustrates generally an example of portions of a system including portions of a detection circuit, wherein portions of the detection circuit include an electrical characteristic 501, a variable oscillator 901, a digitally controlled resistor 1002, a clock signal 802, a fixed oscillator 706, combinational logic 707, a counter 708, a counter signal 1010, a reference value 1007, a comparator 1011, comparator signals 1004, 1005, an up/down counter 1003, a notification signal 714, a delay 1013, a delay signal 1014, a latch 1012, and a latch signal 1006.

In this example, a clock signal 802 can be established using a variable oscillator 901. The frequency of the variable oscillator 901 can be established using an electrical characteristic 501 and a digitally controlled resistor 1002. The value of the digitally controlled resistor 1002 can be established, in part, using a reference value 1007, a counter 708, and a comparator 1011. The reference value 1007 can include a preset reference value. In certain examples, the count interval 607 and control interval 608 can be established using the clock signal 802.

In the example of FIG. 10, the counter 708 can be configured to count the number of clock cycles from the fixed oscillator 706 during the count interval 607. The comparator 1011 can be configured to compare the value of the number of clock cycles using the reference value 1007. In an example, if the comparator 1011 determines that the number of clock cycles is higher than the reference value 1007, then the value of the up/down counter 1003 is increased, which increases the value of the digitally controlled resistor 1002, which causes the frequency of the variable oscillator 901 to decrease. In another example, if the comparator 1011 determines that the number of clock cycles is lower than the reference value 1007, then the value of the up/down counter 1003 is decreased, which decreases the digitally controlled resistor 1002, which causes the frequency of the variable oscillator 901 to increase. The notification signal 714 and delay 1013 can be used to ensure that the value of the digitally controlled resistor 1002 is not updated during a valid contact indication. In an example, the notification signal 714 can be delayed using the delay 1013 and the latch 1012 to allow the detection circuit 104 to stabilize before updating the digitally controlled resistor.

FIGS. 1-10 illustrate various examples, including sensing an electrical characteristic, detecting the physical contact, providing a notification, generating an electrical signal, detecting a change in the electrical characteristic, and determining whether the change in the electrical characteristic meets or exceeds a specified duration, are disclosed. It is to be understood that these examples are not exclusive, and can be implemented either alone or in combination, or in various permutations or combinations.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A system, configured to detect a physical contact by an animal within a specified area of at least one piece of dog agility equipment, comprising:
at least one contact sensor, configured to sense an electrical characteristic indicative of the physical contact;
a detection circuit, coupled to the contact sensor, configured to detect the physical contact using information from the contact sensor; and
a notification circuit, coupled to the detection circuit, configured to provide a notification of the detected physical contact.

2. The system of claim 1, including:
at least one piece of dog agility equipment, wherein the at least one piece of dog agility equipment includes at least one of a ramp, a tunnel, a chute, a teeter-totter, a dog-walk, an A-frame, and a table.

3. The system of claim 3, wherein the at least one piece of dog agility equipment includes a grounding circuit, wherein the grounding circuit includes a conductor, and wherein the conductor is configured to be connected to an electrical ground.

4. The system of claim 1, wherein the at least one contact sensor includes a plurality of contact sensors, wherein the plurality of contact sensors are configured to operate as one or more than one contact zone.

5. The system of claim 4, wherein the plurality of contact sensors are configured, individually or in combination, to operate as one or more than one contact zone.

6. The system of claim 1, wherein the contact sensor includes a conductor.

7. The system of claim 6, wherein the contact sensor includes at least one signal conductor and at least one ground conductor.

8. The system of claim 1, wherein the detection circuit includes:
a signal generation circuit, configured to generate a electrical signal using information from the contact sensor; and
wherein the detection circuit is configured to detect the physical contact using information from the generated electrical signal.

9. The system of claim 1, wherein the detection circuit is configured to detect a change in the electrical characteristic indicative of the physical contact, and wherein the system includes:
a timing circuit, coupled to the detection circuit, configured to determine whether the change in the electrical characteristic meets or exceeds a specified duration; and
wherein the notification circuit, coupled to the timing circuit, is configured to provide a notification using information from the timing circuit.

10. The system of claim 1, wherein the notification circuit includes a physical indicator, wherein the physical indicator includes at least one of a light and a sound.

11. The system of claim 1, wherein the notification circuit includes an electromagnetic signal configured to be received by an electronic device.

12. A system comprising:
means for sensing an electrical characteristic indicative of a physical contact by an animal within a specified area of at least one piece of dog agility equipment;
means for detecting the physical contact using the sensed electrical characteristic; and
means for providing a notification of the detected physical contact.

13. A method comprising:
sensing an electrical characteristic indicative of a physical contact by an animal within a specified area of at least one piece of dog agility equipment using a contact sensor;
detecting the physical contact using the sensed electrical characteristic; and
providing a notification of the detected physical contact.

14. The method of claim 13, wherein the sensing includes sensing an electrical characteristic within one or more than one specified area using a plurality of contact sensors.

15. The method of claim 13, wherein the sensing includes using a contact sensor that includes a conductor.

16. The method of claim 15, wherein the sensing includes using a contact sensor that includes at least one signal conductor and at least one ground conductor.

17. The method of claim 13, including:
generating an electrical signal using information from the sensed electrical characteristic; and
wherein detecting the physical contact includes using information from the generated electrical signal.

18. The method of claim 13, including:
detecting a change in the electrical characteristic indicative of the physical contact;
determining whether the change in the electrical characteristic meets or exceeds a specified duration using a timing circuit; and
wherein providing a notification includes using information from the timing circuit.

19. The method of claim 13, wherein providing a notification includes providing a physical indication, and wherein providing the physical indication includes providing at least one of a light and a sound.

20. The method of claim 13, wherein providing a notification includes providing an electromagnetic signal, configured to be received by an electronic device.
